(19) United States
(12) Patent Application Publication
(10) Pub. No.: US 2020/0166288 A1
(43) Pub. Date: May 28, 2020

(54) Deployable Heat Radiator System and Method for Small Satellite Applications

(71) Applicant: The United States of America as represented by the Secretary of the Navy, San Diego, CA (US)

(72) Inventors: Martin F. Miller, San Diego, CA (US); David T. Wayne, San Diego, CA (US); Dmitriy I. Obukhov, San Diego, CA (US); Kevin Book, San Diego, CA (US)

(73) Assignee: The United States of America as represented by the Secretary of the Navy, San Diego, CA (US)

(21) Appl. No.: 16/199,776

(22) Filed: Nov. 26, 2018

(51) Int. Cl. F28D 15/02; B64G 1/50

(52) U.S. Cl. CPC F28D 15/0233; B64G 1/503

(57) ABSTRACT

A method for cooling a satellite system comprising configuring a plurality of fins to absorb and emit thermal radiation, wherein the ratio of absorptivity/emissivity is less than one; mechanically coupling the plurality of fins to the outside surface of a satellite, wherein the angle of the plurality of fins can be adjusted and controlled such that they can be stowed against the surface of the satellite or deployed; deploying the fins as necessary to expel heat from the satellite.

### FEDERALLY-SPONSORED RESEARCH AND DEVELOPMENT

Deployable Heat Radiator for Small Satellite Applications is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 104542.

### BACKGROUND

Conventionally, electronics are kept cool by using a combination of conduction, convection, radiation, and advection to expel waste heat from a system. Of these three, conduction and convection are the most effective. However, in the vacuum of space, only conduction and radiation are possible. Furthermore, conduction can only be used within the nanosatellite system to spread heat between components. Radiation therefore is the only means to expel heat from the satellite system, and is the basis for this problem.

In industry, many small satellites, or nanosatellite (NanoSat) systems, are limited to the amount of power that can be used on board due to this restraint. Especially if a satellite is in direct sunlight, cooling by radiation will not be sufficient to keep the system at an operational temperature. By implementing deployable fins that function as a heatsink, a NanoSat can conform to the size standards for launch with its fins/heatsink stowed. Once in orbit, the heatsink can deploy to increase the radiative properties of the NanoSat, thus improving the ability of the NanoSat to remove heat from sensitive components.

### BRIEF DESCRIPTION OF THE DRAWINGS

FIG. 1 shows a front view of a nanosatellite with fins in the deployed position in accordance with the Deployable Heat Radiator for Small Satellite Applications.

FIG. 2 shows a bottom view of a nanosatellite with fins in the deployed position in accordance with the Deployable Heat Radiator for Small Satellite Applications.

FIG. 3 shows a front view of an alternate nanosatellite with fins configured orthogonally in the stowed position in accordance with the Deployable Heat Radiator for Small Satellite Applications.

FIG. 4 shows a front view of an alternate embodiment of a nanosatellite with fins configured orthogonally in the deployed position in accordance with the Deployable Heat Radiator for Small Satellite Applications.

FIG. 5 shows a front view of a nanosatellite with half of the fins in the deployed position and the other half of the fins in the stowed position in accordance with the Deployable Heat Radiator for Small Satellite Applications.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment”, “in some embodiments”, and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

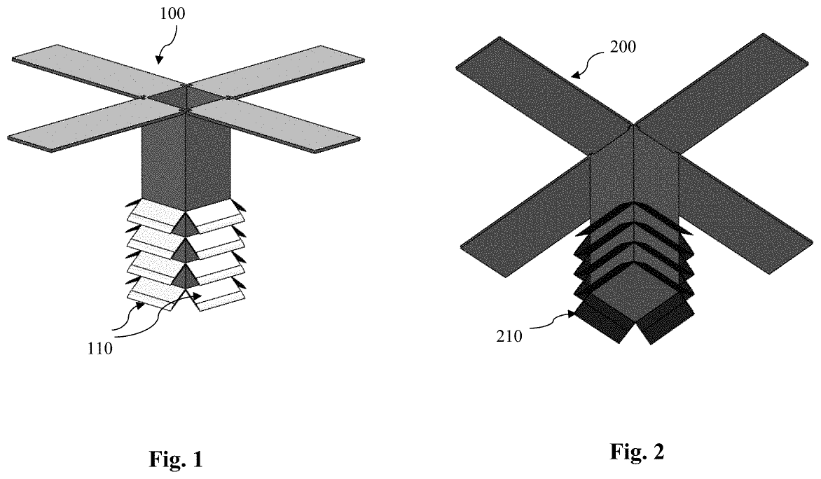

FIG. 1 shows an example of a nanosatellite 100 with a plurality of radiative fins 110. The number and angle of fins 110 depends on the structure of nanosatellite 100 and the overall mission. The goal of any satellite system, also described herein as a spacecraft system, is to maintain the temperature of the electronics and mechanical components in the spacecraft within their operational bounds. This includes keeping the spacecraft cool in direct sunlight, along with keeping the satellite from freezing when it is located in the earth's shadow. Heat is generated in both power generation, conversion, and use. In a small satellite, the primary method of power generation is photovoltaic panels, which is then stored as chemical energy in batteries. When photovoltaics are not generating sufficient power, current is supplemented from the batteries. Typically, the internal power of a satellite is on the order of 1-100 watts. This can be continuous power, or pulsed. The power budget of a satellite has a wide range depending on its mission. Majority of the power consumed is converted to heat and must be disposed.

The thermal environment of a spacecraft is multipart and depends on its position in orbit around the earth.

Q=Qin−Qout

Qin consists of both energy generated internally, Qinternal, and external, Qexternal, sources coming from radiation. There are four normal sources Qexternal of radiation input to the spacecraft. The first and most profound is direct solar flux, on the order of 1200-1600 W/m2 depending on solar activity and earth position in orbit around the sun, beta angle. The primary external sources radiation is based on the following equation:

Qexternal=Qsun+Qalbido+Qother

Qsun=S*α*A*Cos(θ)

Q is the energy absorbed. S is the solar power constant. Alpha is the absorption coefficient of the material. A is the area of satellite under radiation (assume flat plate). Lastly theta is the incidence angle. The three other sources are solar albedo (sun reflected off the earth based on atmospheric conditions), earth infrared, and radiation from stars and the moon. Qinternal is all the heat energy generated by subsystems mentioned in previous section.

Heat is able to equalize and move away from hot components throughout the satellite by conduction. Conduction between two components in contact with each other is defined by the equation:

Q=−k*A*(dt/dx)

Where Q is the heat transfer rate, k is the heat coefficient of the material, A is the heat transfer area, dT is the difference in temperature, and dx is the distance between two points of interest. This equation assumes the two components are made of the same material. In the satellite system, conduction is the means of heat transfer from components that generate heat to components that radiate heat externally.

The radiation of a material is dependent on the surface area, emissivity of the material, and temperature of the material. It is represented by this equation.

P=e*σ*A*T⁴

P is the net radiated power, e is the emissivity factor (from 0 to 1), σ is the Stephen-Boltzmann constant, A is the surface area, and T is the temperature of the emitting surface.

The amount of radiation absorbed by a material is called absorptivity (α). The amount of radiation reflected by a material is called reflectivity (ε). The amount of heat that a surface can absorb or emit is based on the energy balance between absorptivity and emissivity. Absorptivity defines how much energy is attenuated by a material when light hits or passes through it. Emissivity is the measured effectiveness of a material in emitting energy as thermal radiation. One of the goals of this design is to use the materials with a quantified difference in absorptivity and emissivity to leverage the material properties. The ratio of absorptivity/emissivity should be less than one.

Turning back to FIG. 1, radiative fins 110 are located on the outside of nanosatellite 100. Radiative fins 110 are used to maximize the surface area of nanosatellite 100. The plates or fins can be any number, and are dependent on a satellite or spacecraft's design. It is optimal to have fins on the bottom side of the satellite or spacecraft, facing the earth in orbit to avoid excessive direct sunlight, although this is not a requirement.

FIG. 2 shows a bottom view of a nanosatellite 200 with a plurality of fins 210 in the deployed position.

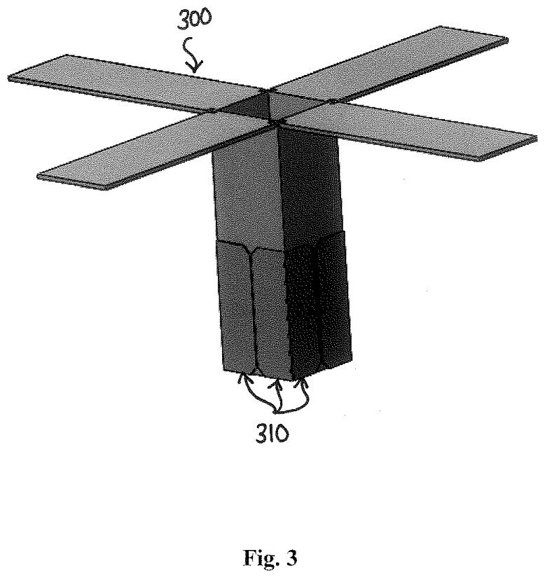

FIG. 3 shows a front view of an alternate embodiment of a nanosatellite 300 with a plurality of fins 310 in the stowed position. Fins 310 have an orthogonal configuration.

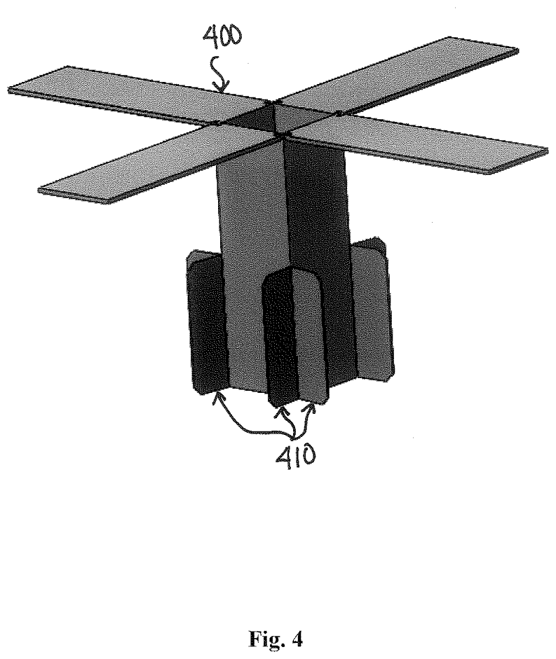

FIG. 4 shows a front view of an alternate embodiment of a nanosatellite 400 with fins 410 in the deployed position. Fins 410 have an orthogonal configuration similar to nanosatellite 300 shown in FIG. 3, except fins 410 are in a deployed position.

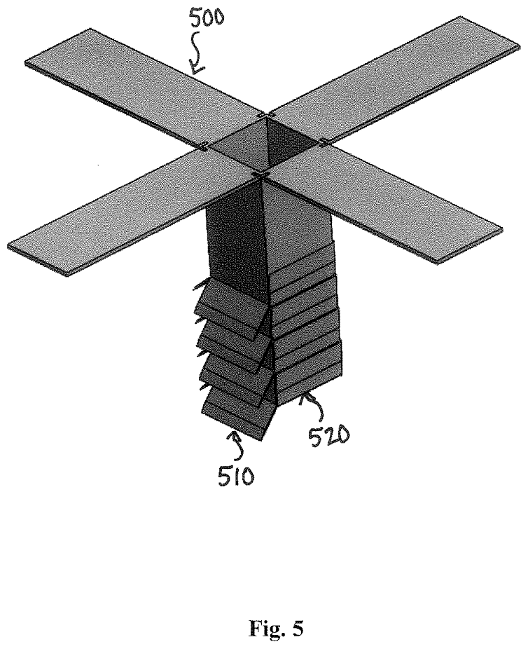

FIG. 5 shows a front view of a nanosatellite 500 with half of the fins 510 in the deployed position and the other half of the fins 520 in the stowed position.

Fin placement and angle is designed to maximize the surface area of the satellite or spacecraft. More fins will increase surface area and therefore increase cooling of the satellite or spacecraft. The fins can be angled with respect to the satellite or spacecraft or be orthogonal. One option is to use mechanical deployment of the fins, which will allow the satellite or spacecraft to be stowed in a smaller package during launch. The fins angle relative to incoming radiation can be adjusted or controlled. Since the magnitude of incoming radiation from the sun or other sources is based on the incidence angle, the fins can be tilted to maximize either direct sunlight, no direct sunlight, or any margin in between. The fins can move independently, or all together, based on the complexity of the spacecraft.

In order to maximize the emitted energy from the satellite or spacecraft and minimize the absorption, the material properties are considered. For radiance, only the surface coating of the fins are considered. Surface coating is any material that is applied to the surface of the satellite or spacecraft, and can be layered, multipart, and/or nonuniform. Tables with the absorptivity to emissivity ratio (A/E) of common materials can be used to determine the proper coating material. Materials with an A/E ratio higher than one are excellent at absorbing energy, but are not ideal for spacecraft design. Materials with a lower than one A/E ratio are going to be able to emit energy typically more than absorb energy. The lower the A/E ratio, the more effective the material (or layers of material) will be at keeping the spacecraft cool. Some examples of materials with high A/E ratios are polished aluminum, galvanized metal, and black paint. Materials with a low A/E ratio (less than 1) are aluminized teflon, white epoxy, and many white paints. Check the outgassing and durability of the paint under UV lighting before use on a spacecraft.

There are multiple alternate embodiments for this system. For example, the radiating fins can be deployable and can be located on other external areas of the satellite or spacecraft. The fins can have alternate shapes and alternate material coatings. A rectangular plate is ideal for the configuration shown but is specific to each satellite. The fin deployment mechanism can be made of a thermally sensitive shape alloy, such that when the thermal loading of the nanosatellite is high, the fins are fully deployed, when the thermal loading is low, the fins are stowed.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A device comprising:
a satellite;
a plurality of fins mechanically coupled to the satellite, wherein the plurality of fins are comprised of a material configured to absorb and emit energy, and wherein the plurality of fins are configured to be in a stowed position or a deployed position depending on the temperature of the satellite.

2. The device of claim 2, wherein the plurality of fins are coated with a surface material having an absorptivity to emissivity ratio of less than one.

3. The device of claim 2, wherein the plurality of fins are mechanically coupled to the outside and bottom of the satellite, and wherein the plurality of fins face the Earth in orbit.

4. The device of claim 3, wherein the plurality of fins are configured to maximize the surface area of the satellite.

5. The device of claim 4, wherein the plurality of fins are coupled to the satellite at an angle relative to incoming radiation.

6. The device of claim 5, wherein the plurality of fins are configured to be adjusted and controlled.

7. The device of claim 2, wherein the plurality of fins are configured to be tilted to maximize either direct sunlight, no direct sunlight, and any margin in between.

8. The device of claim 2, wherein the plurality of fins is configured to move both independently and all together.

9. The device of claim 2, wherein a deployment mechanism is used to deploy the plurality of fins, and wherein the deployment mechanism comprises a thermally sensitive shape alloy, such that when the thermal loading of the nanosatellite is high, the fins are fully deployed, when the thermal loading is low, the fins are stowed.

10. The device of claim 2, wherein the satellite is a NanoSatellite.

11. A method for cooling a satellite system comprising:
configuring a plurality of fins to absorb and emit radiation, wherein the ratio of absorptivity/emissivity is less than one;
mechanically coupling the plurality of fins to the outside surface of a satellite, wherein the angle of the plurality of fins can be adjusted and controlled such that they can be stowed against the surface of the satellite or deployed;
deploying the fins as necessary to expel heat from the satellite.

12. The method of claim 11, further comprising the step of applying a surface coating to the plurality of fins, wherein the surface coating has a high absorptivity to emissivity ratio.

13. The method of claim 12, further comprising the step of using a fin deployment mechanism made of a thermally sensitive shape alloy coupled to the satellite such that when the thermal loading of the nanosatellite is high, the fins are configured to be fully deployed, and when the thermal loading is low, the fins are configured to be stowed.

14. The method of claim 11, further comprising the step of coating the surface of the plurality of fins with aluminized Teflon.

15. A method for maintaining the temperature of a satellite comprising:
mechanically coupling a plurality of radiative fins to the outside of a satellite, wherein the plurality of radiative fins is coated with a surface coating configured to maximize emitted energy from the satellite;
adjusting the angle of the plurality of radiative fins as needed to maintain the temperature of the satellite relative to incoming radiation.

16. The method of claim 15, further comprising the step of coupling the plurality of radiative fins to the satellite in such a way as to maximize the surface area of the nanosatellite.

17. The method of claim 16, further comprising the step of configuring the plurality of radiative fins to be in a stowed position and a deployed position as needed to maintain the temperature.

18. The method of claim 17, further comprising the step of using a deployment mechanism made of a thermally sensitive shape alloy, configured to deploy the plurality of radiative fins when the thermal loading of the satellite is high, and configured to stow the plurality of radiative fins when the thermal loading of the satellite is low.
